(19) United States
(12) Patent Application Publication
(10) Pub. No.: US 2019/0318322 A1
(43) Pub. Date: Oct. 17, 2019

(54) SYSTEM AND METHOD FOR DETERMINING AN ORDER OF FUTURE EVENTS

(71) Applicant: Rithm Al, Inc., Memphis, TN (US)

(72) Inventor: Francis J. Canova, JR., Memphis, TN (US)

(21) Appl. No.: 15/952,145

(22) Filed: Apr. 12, 2018

(51) Int. Cl. G06Q 10/10

(52) U.S. Cl. CPC G06Q 10/1095

(57) ABSTRACT

Methods for scheduling events to optimize an order of future events are disclosed herein. In general, future events are scheduled on the best possible day and time available for the proposed event to optimize the likelihood of a successful meeting or event. This is possible, for example, when there is a common time, or set of times, when two or more parties are available to meet. In some cases, future meeting schedules may be determined based on the shortest traveling time from the user's starting location, the travel time from the event to other clients scheduled for the same day, real-time location of the user, historical event data, such as the scheduling times that have generated successful events in the past for a given client. A successful event may be indicated manually from the user, or by automatic means, for example by determining a sale was completed.

### FIELD

Embodiments of the present invention generally relate to the field of event scheduling. More specifically, embodiments of the present invention relate to computer systems and computerized methods for managing or creating appointments and other events based on historical event data.

### BACKGROUND

There is a strong need, in the field of event scheduling and time management, to organize and optimize an order of future events based on an observed history of past events such that future events are efficiently scheduled to increase the likelihood of a meeting-related success. For example, when a sales person must travel to meet with several clients in a given week, it is useful to generate a schedule that efficiently schedules meetings to optimize efficiency and increase the likelihood of successful sales.

Determining an order of future events manually, using a spreadsheet, for example, is time consuming and typically fails to take into account all available information. There may be hundreds of clients, and a sales person may need to visit many of these clients on a regular basis. Grouping clients together to be visited on a given day requires knowledge of the locations of the clients, travel time between clients, the duration of time needed at a client to successfully complete an event, and should also consider the relative importance of the client or account, and the client's availability and likelihood of engaging. For example, a client's importance may be determined based on the number of previous sales to that account.

Scheduling future events is further complicated by the fact that a client's schedules may change from one week to another, and what may be considered an agreeable time to meet one week may be unavailable the next week. When a client's availability changes, scheduling events with other clients may be more difficult. For example, a meeting with one client may need to be rescheduled if a more important client must also reschedule to that same day and time. When client locations are known, the location of the user relative to a client can show if a client on the schedule was not met and may reschedule that client at a new time. Therefore, it is very helpful if an event schedule can adapt to real-time changes in information.

Some existing techniques provide path estimation that efficiently orders a set of locations, but fail to consider client schedules. Other techniques consider travel time prior to an event, but fail to consider cumulative travel time when traveling to multiple events for scheduling purposes. What is needed is a computer-implemented method for establishing a determined order of future events based on an observed history of past events, such that future events are efficiently scheduled to increase the likelihood of success.

### SUMMARY

Computerized methods for scheduling events to determine an order of future events are disclosed herein. The methods are computer-implemented and may be used to operate a client-server based scheduling system. According to some embodiments, the client is a mobile computing device that displays a GUI interface. In general, future events are scheduled on the best possible day and time available for the proposed event to increase the likelihood of a successful meeting or event. This is possible, for example, when there is a common time, or set of times, when two or more parties are available to meet. In some cases, a future meeting time may be determined based on the shortest traveling time from the user's starting location, the travel time from the event to other clients scheduled for the same day, and historical event data, such as the scheduling times and durations that have generated successful events in the past for a given client. A successful meeting/event may include any engaging activity including the closing of a sale, or successfully combining two substances or materials in a manufacturing processes, for example.

According to one embodiment of the present invention, a method for scheduling remote events is disclosed. The method includes receiving, from a client device, user location data, where the location data includes a geographic location and a timestamp, identifying a plurality of events to be scheduled, where the plurality of events to be scheduled includes an event location and an event frequency, adding events of the plurality of events to be scheduled to a schedule-later queue if a most recent visit time of the respective event is more recent than the respective event frequency, adding events to a schedule-now list when the most recent visit time of the respective event is older than the respective event frequency, and generating a preferred event sequence from the events of the schedule-now list. The generating is based on the event location, the user location data, and historical event data, and the historical event data includes indications of success for past events.

According to another embodiment, an event scheduling system is disclosed. The system includes a receiving module for receiving, from a client device, user location data, where the location data includes a geographic location and a timestamp, an event database for storing historical event data and a plurality of events to be scheduled, where the plurality of events to be scheduled includes an event location and an event frequency, and an event scheduling module for adding events of the plurality of events to be scheduled to a schedule-later queue if a most recent visit time of the respective event is more recent than the respective event frequency, adding events to a schedule-now list when the most recent visit time of the respective event is older than the respective event frequency, and generating a preferred event sequence from the events of the schedule now list. The generating is based on the event location, the user location data, and the historical event data, and the historical event data includes indications of success for past events. When a user leaves an event (known when the user's location differs significantly from the location of the event) the user may be asked to indicate the completion or success of that event. The level of completion or success will be recorded with the event time an duration in the historical event data. The historic event data can be used when scheduling events to help identify the best time and durations for successful events in the future.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of an exemplary computer system upon which embodiments of the present invention may be implemented.

FIG. 2 is a block diagram depicting an exemplary event scheduling system according to embodiments of the present invention.

FIG. 3 is a data flow diagram depicting the flow of data for an exemplary event scheduling system according to embodiments of the present invention.

FIG. 4 is a flowchart depicting steps of an exemplary computer-implemented method of event scheduling according to embodiments of the present invention.

FIG. 5 is a screenshot of an exemplary graphical user interface (GUI) for an event scheduling client application depicted according to embodiments of the present invention.

FIG. 6 is a screenshot of an exemplary graphical user interface (GUI) for reviewing and classifying events using an event scheduling client application executed by mobile computing device depicted according to embodiments of the present invention.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

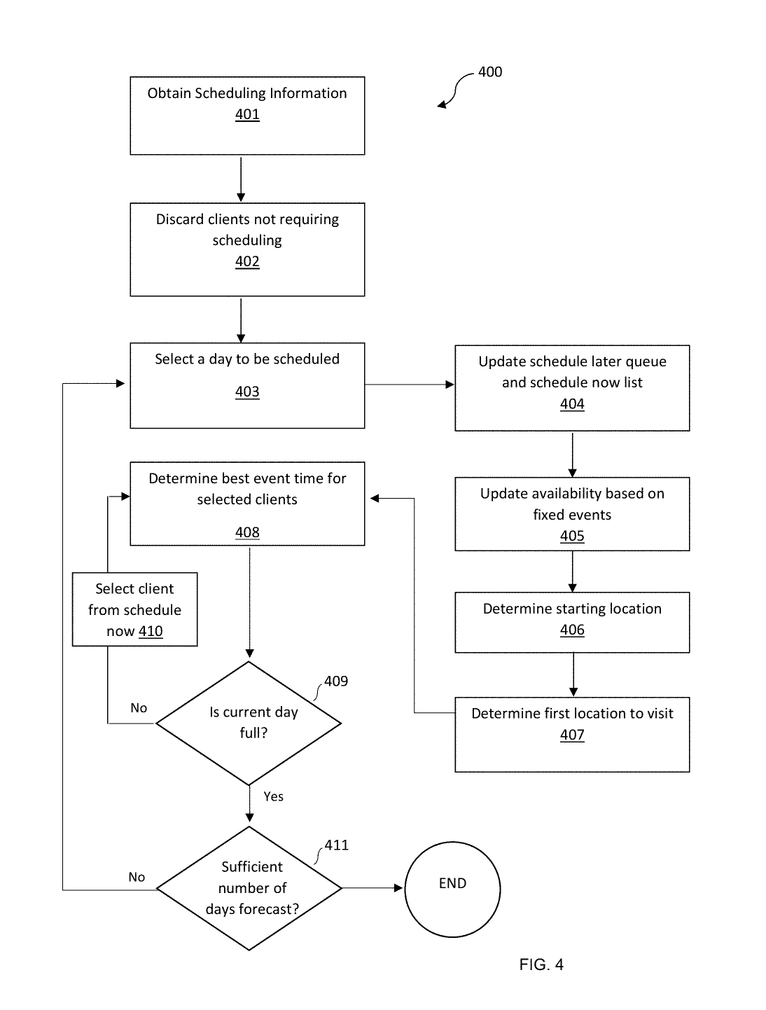

Portions of the detailed description that follows are presented and discussed in terms of a method. Although steps and sequencing thereof are disclosed in a figure herein (e.g., FIG. 4) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying,” “scheduling,” “updating,” “determining,” “selecting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Exemplary Computer System

Embodiments of the present invention are drawn computer systems for scheduling future events based on historical event data. The following discussion describes one such exemplary computer system, which can be used as a server platform and/or a mobile platform.

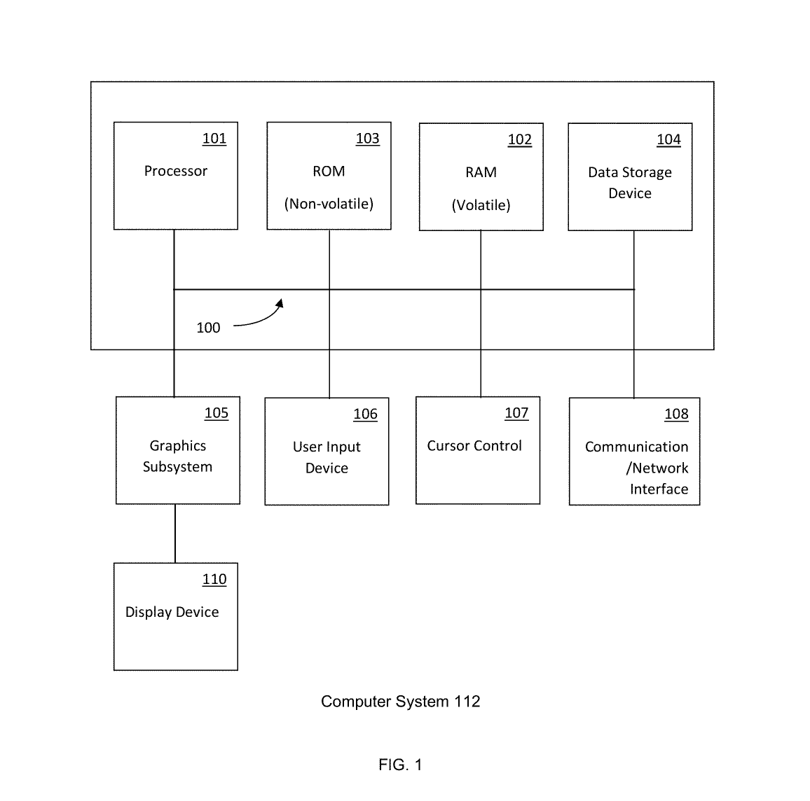

In the example of FIG. 1, the exemplary computer system 112 includes a central processing unit (CPU) 101 for running software applications and optionally an operating system. Random access memory 102 and read-only memory 103 store applications and data for use by the CPU 101. Data storage device 104 provides non-volatile storage for applications and data and may include fixed disk drives, removable disk drives, flash memory devices, and CD-ROM, DVD-ROM or other optical storage devices. The optional user inputs 106 and 107 comprise devices that communicate inputs from one or more users to the computer system 112 (e.g., mice, joysticks, cameras, touch screens, and/or microphones). According to some embodiments, the computer system 112 is a mobile computing device, such as a smartphone or tablet.

A communication or network interface 108 allows the computer system 112 to communicate with other computer systems, networks, or devices via an electronic communications network, including wired and/or wireless communication and including an Intranet or the Internet. The display device 110 may be any device capable of displaying visual information in response to a signal from the computer system 112 and may include a flat panel touch sensitive display, for example. The components of the computer system 112, including the CPU 101, memory 102/103, data storage 104, user input devices 106, and graphics subsystem 105 may be coupled via one or more data buses 100.

Some embodiments may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

### System and Method for Determining an Order of Future Events

Methods for determining an order of future events are disclosed herein. In general, future events are scheduled on the best possible day and time available for the proposed event to increase the likelihood of a successful meeting. This is possible, for example, when there is a common time, or set of times, when two or more parties are available to meet. As another example, when scheduling the manufacturing of a product, a time when two materials are available to be combined may be considered to determine a best possible day and time to schedule a manufacturing process. As described herein, a meeting time or event may refer to an in-person meeting, a phone or teleconference call, or a manufacturing process involving two or more materials or components, for example. A successful meeting/event may include the closing of a sale, signing a new agreement or meeting a new client or a new customer, or any other form of engagement, or successfully combining two substances or materials in a manufacturing process, for example.

According to some embodiments, a schedule of future events is generated based on data related to the frequency and duration of the event (e.g., one 30 minute meeting every week), the relative importance of the event, and the past history of event success. The frequency and duration of the event may lead to a relatively high number of events that need to be scheduled at the same time. As such, the timing of events may be redistributed over a longer time period when there are a sufficiently high number of events, or events of a sufficiently long duration, are scheduled. The order of event distribution may be based on the importance of the event, the travel time to the next event scheduled, client availability, and historical success rate, for example.

The relative importance of an event is determined based on a comparison to other events. Higher priority events are typically scheduled earlier than lower priority events, even if the availability of the two events is exactly the same. However, if a lower priority event is ignored more than a threshold number of times (e.g., 5 times in a month, for instance), the priority of the event may be raised such that the event will eventually be scheduled prior to an event that previously had a higher priority.

A past history of successful events is also an important consideration when generating a schedule of future events. The days and/or times when a past event was successful may be given higher priority when scheduling future events compared to days and/or times when a past event was not successful. Event success may include a number of factors, such as the outcome of the event (e.g., closing of a sale), the amount of revenue generated from the event, how well the parties met (socially) or the materials met (physically) during the event. For example, a positive social introduction, or an effective matching of skill sets between parties, may be considered a successful outcome. The successful binding of two materials may be considered a positive outcome for a manufacturing process.

Some events may be defined as fixed-time events, where the event must occur at a pre-defined time. For these events, the scheduling of future events may be blocked by the fixed-time event because the date and time of the fixed-time event cannot be changed. Once the fixed-time events are entered or identified, the remaining events are scheduled or adjusted accordingly.

When scheduling in-person events, to increase the likelihood of a successful event, an otherwise available event time may become unavailable due to the travel time necessary to bring two parties together in physical proximity. In general, when an event requires a greater amount of travel time, the number of available meeting times is substantially reduced. The amount of travel time between parties or materials can also prohibit scheduling an event at certain times. For example, when travel time is above a threshold, wear on the parties or materials due to travel or transportation may render a certain meeting time or place undesirable. In some cases, too much travel time can lead to exhaustion and/or poor performance, and required materials may degrade or expire. As such, travel time to an event for one or more parties will be used as a factor to determine which parties are available to meet and when the event can be scheduled.

According to some embodiments of the present invention, techniques are employed to mitigate the total amount of travel time experienced. According to one technique, the number of total events scheduled for a day will be reduced. In this way, when fewer total events are scheduled, the total travel time experienced is reduced. According to another technique, an additional event is inserted on the travel path between two scheduled events. When the additional event is added between stops, a resting non-travel period is automatically added based on the event duration. Travel time may be affected by a number of considerations, including physical location. The greater the distance between the two parties, the more travel time is generally required. Other factors that influence travel time include environment, such as weather or traffic conditions between the two parties.

### Event Scheduling System

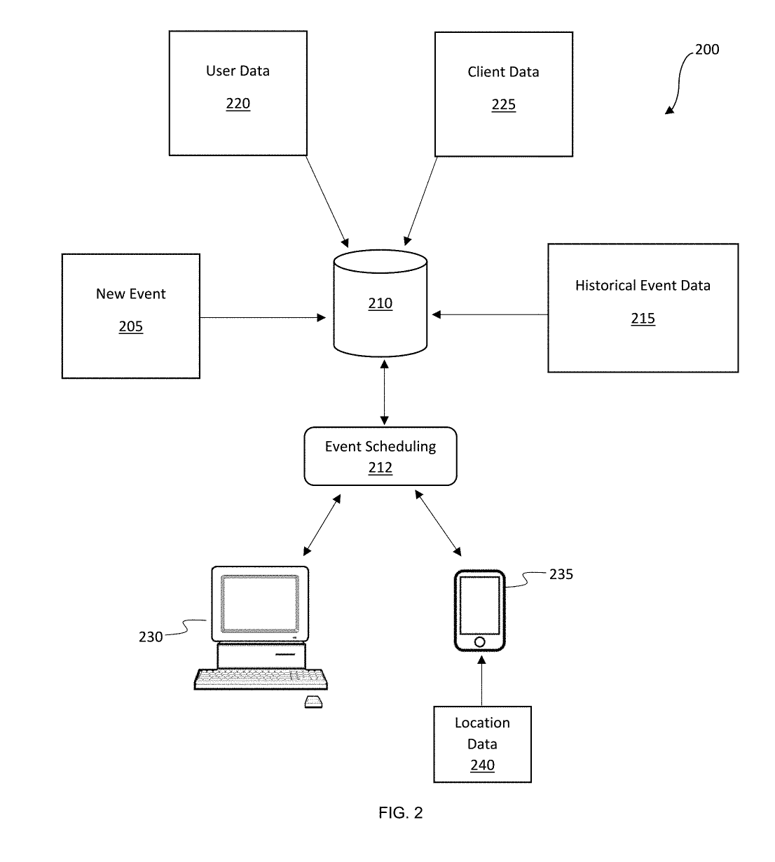

With regard to FIG. 2, an exemplary event scheduling system 200 is depicted according to embodiments of the present invention. An event scheduling module 212 (e.g., software module) communicates with an event scheduling database 210 that stores event data, including historical event data 215. Database 210 can be realized using a number of different well-known database technologies. Event data stored in event scheduling database 210 may include times when a user is available, times when a client is available, event location data, travel time data, event duration data, and event frequency data, for instance. The event scheduling database 210 also receives new event data 205 from a client device (e.g., a personal computer, mobile computer, smartphone, or tablet) to be stored in event scheduling database 210. Events may be processed and sorted into a schedule-now list and a schedule-later queue, and ultimately scheduled into an event sequence.

A historical record of event data 215 from previous events is stored in event scheduling database 210. The historical data 215 is used to determine scheduling for future events to increase the likelihood of success. Using historical data 215, individual schedules may be automatically adjusted in real-time by event scheduling module 212 based on the time when a user has actually arrived and departed from a meeting with a client as determined by matching the location data 240 with one or more clients in the client data 225 which contains a location for each client, the time when a user indicates that the event (e.g., the meeting with the client) is complete, and travel conditions (e.g., rush hour, congested paths, and road construction). Historical data 215 may also be used by event scheduling module 212 to automatically adjust a schedule based on dates and times of previous successful events with the client. Past events may be automatically determined to be successful based orders received, request for samples or demos, and the canceling or rescheduling of a meeting, for example. Past events may also be manually determined to be successful by asking the user to classify past visits as shown on clients 230 or 240.

The event scheduling database 210 also stores user data 220 and client data 225 for determining future event scheduling. User data 220 may include preferences set by a user that help determine an appropriate event schedule for that user. For example, a user can establish a preference for acceptable work hours, starting location or vacation schedule. Other examples of user preference stored in user data 220 include setting a threshold “long drive” distance, where no two events that qualify as “long drives” will be scheduled in the same day. A “run-over” preference may be set to allow the times of subsequent meeting to overlap, for example, when a meeting is scheduled even though the estimated duration is greater than the available work hours. “Double-backs” may be enabled to allow scheduling events that require traveling outside of an area and returning as long as the total distance is within a defined threshold.

Client data 225 includes data regarding the clients to be met with, such as client importance and organization and one or more office locations (including geolocation, street address, and other contact information), available office hours, vacation schedule, desired frequency of visits and duration of visits and best time to have a successful event, where the duration and best event times may be determined based on historic event data 215. Client importance may be based on size of past sales, number of past sales, revenue generated by the account, etc. For some clients, sales may follow a seasonal sales cycle, or sales may predictably increase or decrease due to an intervening event. The relative importance of these clients may be adjusted automatically based on the sales cycle or intervening event.

Some clients are only available at certain times of the day, and clients may work at multiple offices. In this case, because the client can only be in one location at a time, the event scheduling system can automatically pick the optimal location based on travel time and opportunity to visit other high-importance clients, for example. Furthermore, in some cases, a determined event sequence includes visiting the group members at the same time, such as when clients are grouped into an organization or office. If the client group is too large to schedule all meetings on the same day, the events may be split over two or more days. Some clients within the group may be representatives of other clients, and the representation may be considered by the event scheduling 212 to avoid unnecessary or redundant meetings. In some cases, the client's office configuration (e.g. number of floors, buildings, offices) will be considered, and events will be scheduled in a distance-appropriate order. For example, the scheduling system may schedule all 1^{st} floor meetings before noon, and schedule all 4^{th} floor meetings after noon.

Exemplary client devices 230 (e.g., shown as a desktop computer) and 235 (e.g., a mobile computer or smartphone) communicate with event scheduling module 212 over a communication network, such as the Internet or a local area network. As depicted in FIG. 2, client device 230 is a personal computer, and client device 235 is a mobile computing device, such as an Android smartphone or Apple iPhone. The mobile computing device receives user location data 240 such as from a global positioning system and communicates the location data in real-time to event scheduling module 212. Event scheduling module 212 may update the scheduled event sequence based on the real-time user location. The event scheduling 212 module and the event database 210 may be implemented as hardware components of a computer system, or as executable software, such as software modules or applications, according to embodiments of the present invention.

Sometimes an unforeseen event causes the user to visit an unscheduled client. The new location data 240 can be used to determine which client is being visited by comparing the location data 240 with the location of each client in the client data 225. The event scheduling 212 may then recommend a new schedule based on the location data 240.

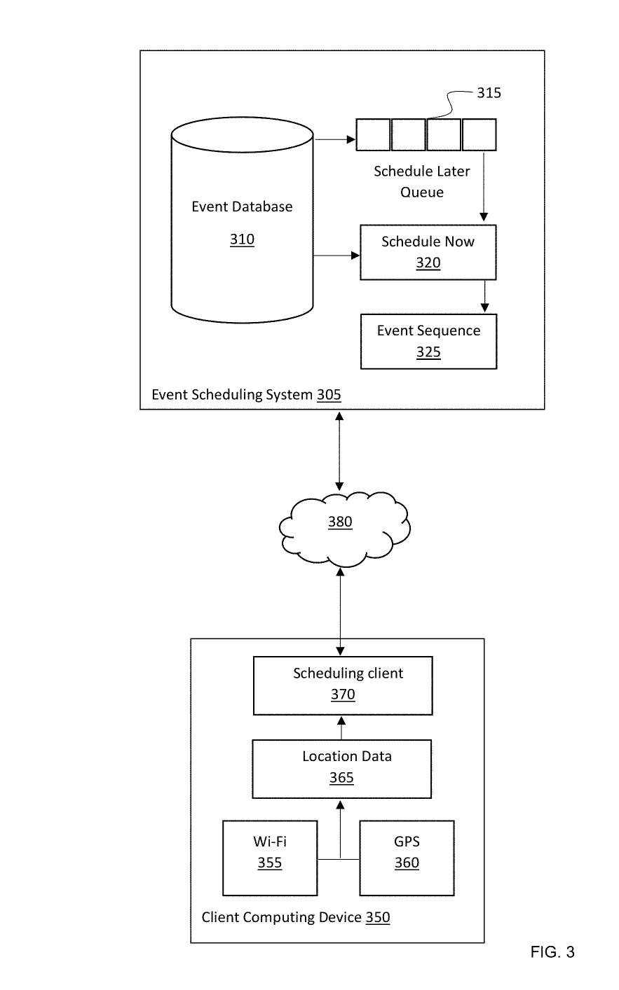

With regard to FIG. 3, an exemplary data flow diagram of an event scheduling system is depicted according to embodiments of the present invention. A client computing device 350, which may include a personal computer, smartphone, or tablet computer, sends and receives data over a network 380 (e.g., the Internet) to communicate with event scheduling system 305. According to some embodiments, Wi-Fi transceiver 255 and GPS receiver 360 are used to generate location data 365 associated with the client computing device 350. The location data 365 can be used to determine the user's geographic location in real-time, and may be transmitted to the event scheduling system 305 over network 380 to update event sequence 325 based on the user's current location and, for example, the distance between the user's current location and the location of the next scheduled event.

Scheduling software client 370 executed on client computing device 350 receives scheduling information from the event scheduling system 305, including events scheduled in event sequence 325. The scheduling client 370 may also add new clients and/or new events to event database 310, and the event sequence 325 may be updated accordingly. According to some embodiments, after a new event has been added to event database 310 using client device 350, the user may send a ‘sync’ command from client device 350 that causes the event sequence 325 to be updated using the newly entered data.

The event scheduling system 305 maintains a database of events, including, for example, event location, client availability, user availability, travel time, event duration, and event frequency in event database 310. Events from event database 310 that do not require immediate scheduling are added to schedule-later queue 315. For example, events may be added to the schedule-later queue 315 when the time of the most recent visit is more recent than the defined event frequency. Events are periodically pulled from the schedule-later queue and added to the schedule-now list, for example, when the time of the most recent visit is older than the defined event frequency.

According to some embodiments, a method of scheduling events based on historical event data is used to determine an event sequence 325 that increases a likelihood of success for the scheduled events. The event sequence 325 includes a list of scheduled events, the respective times and locations, and the parties that will be in attendance. Other information may optionally be include in event sequence 325, such as contact information, company information, etc. FIG. 4 depicts an exemplary method for scheduling events based on historical event data according to embodiments of the present invention.

### Event Scheduling Method

With regard to FIG. 4, an exemplary computer-implemented method of event scheduling 400 is depicted according to embodiments of the present invention. At step 401, scheduling information is generated or obtained. The scheduling information may include user data, client data, and historical event data, among other information. For example, according to some embodiments, event data stored in event scheduling database 210 includes user availability data, client availability data, event location data, travel time data, event duration data, and event frequency data.

At step 402, clients that do not presently require scheduling are identified and discarded based on the scheduling information obtained in step 401. The criteria for determining which clients require scheduling includes:

a) Event frequency—an event with an event frequency of zero (such as a client to only schedule by appointment) may not need to be scheduled

b) Importance level—an event with an importance level outside of a selected range may be skipped

c) Availability—a client that is unavailable for the foreseeable future may not need to be scheduled

d) Location—if the location of a client is unknown the event will not be scheduled until the location is determined

e) Client group—for multiple clients in a group with no overlapping availability, the event may not need to be scheduled until there is mutual availability

An upcoming day to be scheduled is selected at step 403, and steps 404-410 are performed to schedule events for the selected day. Days where the user is known to be unavailable, such as weekends, holidays, or scheduled vacations, may be skipped. At step 404, clients are added to a schedule-later queue if the time of the most recent visit is more recent than the defined event frequency. Clients are pulled from the schedule-later queue and added to a schedule-now list when the time of the most recent visit is older than the defined event frequency. For example, if an event frequency indicates that the client should be visited once per 30 days, and the most recent visit with the client was 12 days ago, the event is added to the schedule-later queue. For example, if the most recent visit was 31 days ago with that same client, then the event is moved to the schedule-now list.

At step 405, events that require fixed-time scheduling for the selected day are identified, and the corresponding time is marked as unavailable for the user.

Additionally, clients that are located at the location of the fixed-event may optionally be removed from the pool of clients to be scheduled. If there are clients with additional fixed-time events within a few days of the selected day, and the fixed-time event are scheduled to take place at the same location as the initial fixed-time event, those clients may be added to the schedule-later queue.

At step 406, the starting location for the selected day is identified. If one or more fixed-time events are scheduled for that day, the starting location identified by the event scheduling system is the location of the fixed-time event closest to the user. In cases where the user is traveling, the starting location is the location of the user, for example, as provided by a client device using GPS coordinates. Otherwise, the starting location is the user's home location (e.g., the user's home or office).

At step 407, the location of the first event to be visited by the user is identified. If the user's starting location for the selected day is their home location, the client with the highest relative importance is selected from the clients to be scheduled now (e.g., clients from the schedule-now list). If the user's starting location is not their home location, the client determined to be closest to the user's starting location on the selected day is identified from the clients to be scheduled now.

At step 408, times for scheduling the selected clients are determined. Initially, all possible scheduling times available for both the clients and the user are determined. From the possible times where both client and user are available, favorable scheduling times are identified based on one or more of:

a) Shortest traveling time from the user's starting location

b) Travel time from the event to other clients scheduled for the same day

c) Historical event data, specifically, the scheduling times that have generated successful events in the past for a given client

In some cases, the client's availability, travel time, and meeting duration cannot be accommodated by the schedule due to time constraints, and the event is added to the schedule-later queue. Once an event is scheduled, it is also added to the schedule-later queue so that it can be reschedule on a future day based on its event frequency.

After initial scheduling times have been determined at step 408, the scheduling system determines if there is any remaining time available to schedule events for the selected day at step 409. If the scheduling system determines that there is more time available, at step 410, an additional client is selected from the schedule now queue. The next client selected may be the client on the schedule-now list that is closest to the previously scheduled client. If there are more than one client at a similar distance to the previous client, then the client with the highest relative importance may be selected. The method returns to step 408, and event times for the clients are determined. Steps 408-410 are repeated until the scheduling system determines that here is no additional time available for the selected day. After the selected day is determined to be full at step 409, step 411 is performed to determine if the schedule-now list is empty. If more days should be forecast, the method returns to step 403 to select another day for scheduling. If the schedule-now list is empty, the process ends.

### Event Scheduling Client Graphical User Interface

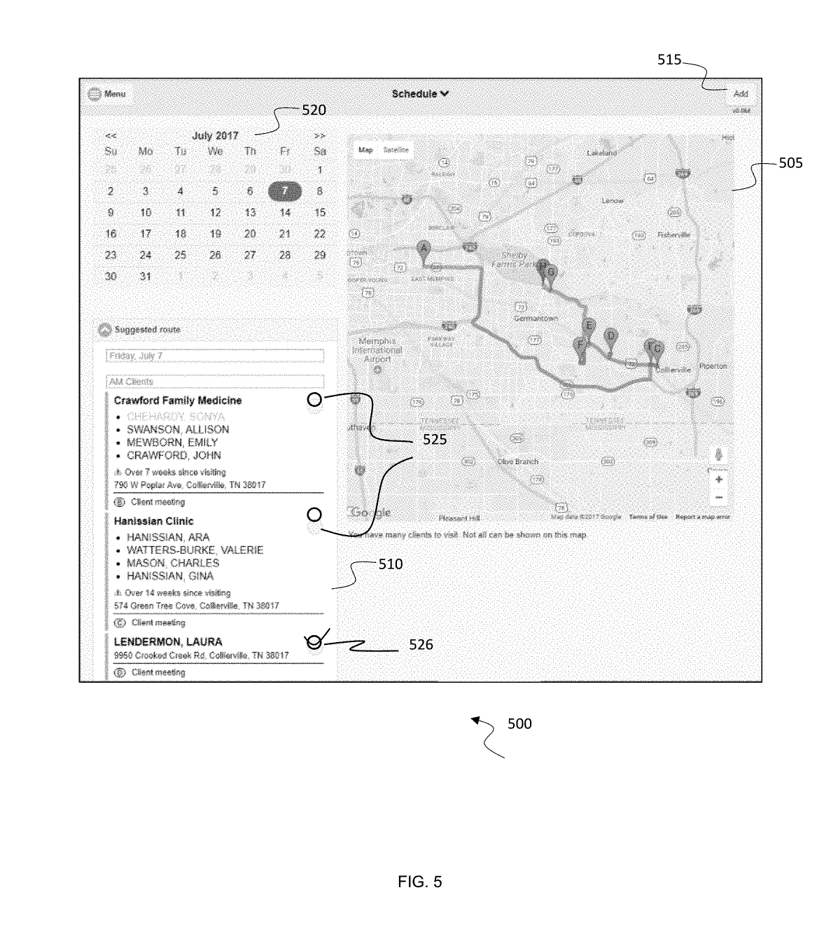

With regard to FIG. 5, a screenshot of an exemplary graphical user interface (GUI) 500 for an event scheduling client is depicted according to embodiments of the present invention. The event scheduling client sends and receives data to communicate with a remote event scheduling system. Exemplary event list 510 includes future events scheduled in an event sequence of the remote scheduling system. The exemplary event list 510 includes the name of the client, the location of the event, and the length of time since the previous visit with the client. Events 510 may be marked by the user at 525 when the event is completed successfully. This mark may also allow the user to include a level of success of the event. The time and success level is saved in the historic event data and used to determine the best time, duration and frequency when scheduling future events. Completion may be automatic based on the user's location or manually through other graphical means such as a swiping motion on a touch screen or through pop-up menus.

The GUI 500 may be configured to list events scheduled for a certain day, where the day is user selectable, or to list events that meet keyword or filter constraints entered by the user. In this way, the user may configure the exemplary event list 510 to only display events for a given client or at a specific location. For example, the user may select a day on calendar 520 to display only events for the selected day, or enter a keyword “Crawford” to display events for Crawford Family Medicine.

Event map 505 is updated in accordance with the event sequence generated for the user. Each event is marked on the map, and the chosen path (e.g., the fastest path or the shortest path, for instance) between locations is displayed. The user may add additional events by selecting add event button 515. The user is prompted to enter event details, such as an event name, location, and duration, which are communicated to the event scheduling system. The user's event sequence may then be updated based on the newly added event information.

The event scheduling client may also provide information to the event scheduling system automatically without user interaction. For example, the travel time between clients may be determined by the event scheduling client based on geolocation data observed by the event scheduling client. The duration of an event may be determined by the event scheduling client based on geolocation data taken at the client's location. If the event scheduling client determines that a user did not visit with a scheduled client, the system may determine that the event is less likely to be completed successfully. On the other hand, if the user marks an event as complete 526, the specific time of the event is noted to be more likely to be successful in the future. This information is communicated to and stored in an event scheduling database, and is used by the event scheduling system to schedule future events.

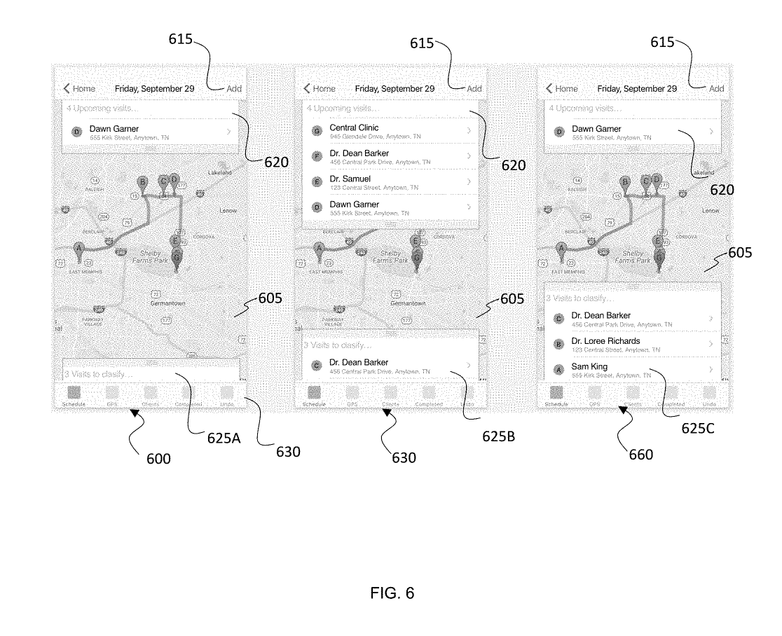

With regard to FIG. 6, a screenshot of an exemplary graphical user interface for reviewing and classifying events using an event scheduling client application executed by mobile computing device depicted according to embodiments of the present invention. The event scheduling client sends and receives data to communicate with a remote event scheduling system. Exemplary event list 620 includes future events scheduled in an event sequence of the remote scheduling system. The exemplary event list 620 includes the name of the client and the location of the event. The time and success level of events is saved in historic event data and used to determine the best time, duration and frequency when scheduling future events. Event completion may be automatic based on the user's location or manually through other graphical means such as a swiping motion on a touch screen or through pop-up menus.

Event map 605 is updated in accordance with the event sequence generated for the user. Each event is marked on the event map 605, and the chosen path (e.g., the fastest path or the shortest path, for instance) between locations is displayed. The user may add additional events by selecting add event button 615. The user is prompted to enter event details, such as an event name, location, and duration, which are communicated to the event scheduling system. The user's event sequence (e.g., event list 620) may then be updated based on the newly added event information.

Event classification list 625 displays past events that have not yet been classified or scheduled. By interacting with the classification list 625 (e.g., dragging upward), the classification list 625 is expanded to display the past events to be classified. For example, GUI 600 shows a minimized or closed classification list 625A, GUI 630 shows an opened classification list 625B, and GUI 660 shows an expanded classification list 635C. A user may select a specific past event to provide a classification for the event (e.g., an indication of success). As the events are classified and/or completed, the event map 605 and event list 620 are updated accordingly. Event list 620 may be opened and expanded similar to event classification list 625A.

Embodiments of the present invention are thus described. While the present invention has been described in particular embodiments, it should be appreciated that the present invention should not be construed as limited by such embodiments, but rather construed according to the following claims.

What is claimed is:

1. A computer-implemented method for scheduling events, said method comprising:
receiving, from a client device, user location data, wherein the location data comprises a geographic location and a timestamp;
identifying a plurality of events to be scheduled, wherein each of the plurality of events to be scheduled comprise a respective event location and an event frequency;
adding events of the plurality of events to be scheduled to a schedule-later queue if a most recent visit time of a particular event is more recent than its respective event frequency;
adding events to a schedule-now list when a most recent visit time of a particular event is older than its respective event frequency; and
generating a preferred event sequence from a set of events of the schedule-now list,
wherein said generating is based on event location data, user location data, and historical event data of said set of events, and wherein the historical event data comprises indications of success for past events.

2. A method as recited in claim 1, further comprising:
receiving a fixed-time event from the client device;
adjusting the preferred event sequence based on a fixed-time and a fixed-location of the fixed-time event if the fixed-location is known.

3. A method as recited in claim 1, further comprising receiving event importance metrics from the client device and wherein said generating a preferred event sequence comprises scheduling events having a higher event importance metric in said preferred event sequence before scheduling events with a lower event importance metric when scheduling events for a time slot.

4. A method as recited in claim 1, wherein each of said plurality of events to be scheduled further comprises a respective event duration, wherein said respective event duration is automatically updated according to the user location data, and wherein said generating a preferred event sequence is performed based on said respective event duration.

5. A method as recited in claim 4, wherein said respective event duration is automatically generated based on historical event duration data.

6. A method as recited in claim 3, further comprising receiving, from said client device, an indication of success for an event, wherein said generating a preferred event sequence is further based on said indication of success, and further comprising increasing the event importance metric for the corresponding event responsive to the indication of success.

7. A method as recited in claim 1, wherein said generating a preferred event sequence is further based on an event availability and a user availability and comprises scheduling a future event only for a time that comprises both event availability and user availability.

8. A computer system for scheduling remote events, said system comprising:
a receiving module for receiving, from a client device, user location data, wherein the location data comprises a geographic location and a timestamp;
an event database for storing historical event data and a plurality of events to be scheduled, wherein each of the plurality of events to be scheduled comprises a respective event location and a respective event frequency;
an event scheduling module for adding events of the plurality of events to be scheduled to a schedule-later queue if a most recent visit time of a particular event is more recent than its respective event frequency, and for adding events to a schedule-now list when the most recent visit time of a particular event is older than its respective event frequency, and for generating a preferred event sequence from a set of events of the schedule now list,
wherein said generating is based on event location data, said user location data, and said historical event data of said set of events, and
wherein said historical event data comprises indications of success for past events.

9. The system as recited in claim 8, wherein said receiving module is configured to receive a fixed-time event from the client device, and wherein said event scheduling module is configured to adjust the preferred event sequence based on a fixed-time and may have a fixed-location of the fixed-time event.

10. The system method as recited in claim 8, wherein said receiving module is configured to receive event importance metrics from the client device, and wherein said event scheduling module is configured to generate said preferred event sequence comprises scheduling events having a higher event importance metric within said preferred event sequence before scheduling events with a lower event importance metric when scheduling events for a time slot.

11. A system as recited in claim 8, wherein each of said plurality of events to be scheduled further comprises a respective event duration and wherein said event scheduling module is configured to automatically update said event duration according to the user location data, and generate the preferred event sequence based on said event duration.

12. A system as recited in claim 11, wherein said event scheduling module is configured to automatically generate said event duration based on historical event duration data.

13. A system as recited in claim 10, wherein said receiving module is configured to receive, from said client device, an indication of success for a corresponding event, wherein said event scheduling module is configured to:
generate the preferred event sequence based on said indication of success; and
increase said event importance responsive to the indication of success.

14. A system as recited in claim 8, wherein said event scheduling module is configured to generate the preferred event sequence based on an event availability and a user availability wherein a future event may only be scheduled for a time that comprises both event availability and user availability.

15. A computer system for scheduling remote events, said system comprising:
a memory unit storing a database for storing historical event data and a plurality future events, wherein each of the future events comprise a respective event location and a respective event frequency; and
a processor communicatively coupled to the memory unit and configured to perform a method of scheduling remote events, said method comprising:
receiving, from a client device, user location data, wherein the location data comprises a geographic location and a timestamp;
identifying a plurality of events to be scheduled, wherein each of the plurality of events to be scheduled comprise a respective event location and an event frequency;
adding events of the plurality of events to be scheduled to a schedule-later queue if a most recent visit time of a particular event is more recent than its respective event frequency;
adding events to a schedule-now list when a most recent visit time of a particular event is older than its respective event frequency; and
generating a preferred event sequence from a set of events of the schedule now list,
wherein said generating is based on event location data, user location data, and historical event data of said set of events, and wherein the historical event data comprises indications of success for past events.

16. A computer system as recited in claim 15, wherein said method further comprises:
receiving a fixed-time event from the client device; and
adjusting the preferred event sequence based on a fixed-time, and a fixed-location of the fixed-time event if the fixed-location is known.

17. A computer system as recited in claim 15, wherein said method further comprises further comprising receiving event importance metrics from the client device and wherein said generating a preferred event sequence comprises scheduling events having a higher event importance metric in said preferred event sequence before scheduling events with a lower event importance metric when scheduling events for a time slot.

18. A computer system as recited in claim 15, wherein each of said plurality of events to be scheduled further comprises a respective event duration, wherein said respective event duration is automatically updated according to the user location data, and wherein said generating a preferred event sequence is performed based on said respective event duration.

19. A computer system as recited in claim 18, wherein said event duration is automatically generated based on historical event duration data.

20. A computer system as recited in claim 17, wherein said method further comprises receiving, from said client device, an indication of success for a corresponding event, wherein said generating a preferred event sequence is further based on said indication of success, and further comprising increasing the event importance metric for the corresponding event responsive to the indication of success.
